(19) United States
(12) Patent Application Publication
(10) Pub. No.: US 2019/0007941 A1
(43) Pub. Date: Jan. 3, 2019

(54) Device, Method and System to Implement Preemptive Transmission of a Wireless Time Sensitive Network Frame

(71) Applicant: Intel Corporation, Santa Clara, CA (US)

(72) Inventors: Dave Cavalcanti, Portland, OR (US); Alexander W. Min, Portland, OR (US); Shahrnaz Azizi, Cupertino, CA (US)

(73) Assignee: Intel Corporation, Santa Clara, CA (US)

(21) Appl. No.: 15/635,401

(22) Filed: Jun. 28, 2017

(51) Int. Cl. H04W 72/04; H04W 72/08; H04L 5/14; H04W 52/24; H04B 7/26

(52) U.S. Cl. CPC H04W 72/0446; H04W 72/082; H04L 5/1461; H04W 84/12; H04W 52/241; H04B 7/2656; H04L 5/14

(57) ABSTRACT

A wireless communication device, system and method. The device may include a memory storing instructions, and processing circuitry coupled to the memory to execute the instructions. The processing circuitry may be configured to: generate a Time Sensitive Network (TSN) frame addressed to a wireless access point; preempt transmission of a downlink frame being transmitted by the access point and cause transmission of the TSN frame to the access point, preempting transmission of the downlink frame being in response to a determination that a priority of the downlink frame is lower than a priority of the TSN frame; and cause transmission of the TSN frame to the access point during transmission of the downlink frame by the access point in full duplex in response to a determination that the priority of the downlink frame is higher than a priority of the TSN frame.

### TECHNICAL FIELD

Embodiments generally relate to the management of wireless networks. Specifically, embodiments generally relate to wireless traffic shaping using frame preemption in the context of transmitting Time Sensitive Network (TSN) frames, for example TSN frames compliant with TSN standards developed by the IEEE 802.1 Working Group's Time-Sensitive Networking Task Group.

### BACKGROUND

Time Sensitive Networks (TSNs) aim to ensure time synchronization and timeliness with respect to critical data flows while taking into consideration deterministic latencies, reliability and traffic redundancies. TSNs may include networks where the data traffic is compliant with IEEE 802.1 as noted above. TSNs have many use cases, some of which involve Internet of Things (IoT) verticals such as Industrial Internet (e.g. involving process control, autonomous machines, etc.); automotive applications (e.g. involving in-vehicle instrumentation, control and infotainment); utility networks; building automation, pro and/or consumer audio and video applications, to name just a few.

TSN applications typically use wired connectivity, such as by way of a number of well-known proprietary wired protocols, although emerging standards are aiming to enable the use of TSNs over Ethernet. Wired connectivity is often not suitable for TSN applications, which applications tend to require control of fast-moving or rotating objects. In addition, wireless technologies such as the wireless technology set forth in the Institute of Electrical and Electronics Engineers (IEEE) 802.15.4e standard, or cellular standards, such as the third generation of wireless mobile telecommunications technology (3G), or the fourth generation of wireless mobile telecommunications technology (4G), do not have the speed or capacity required to meet the latency (low) and reliability (high) requirements in a converged environment involving both cellular and TSN traffic. Even future fifth generation wireless mobile telecommunications technology (5G), which aims for latencies in the order of 1 ms, may not be able to meet TSN applications' extremely low latency requirements (latency requirements may vary depending on specific applications, but extremely low latency requirements may for example range from 10 μsec to 10 msec). Wi-Fi is a potential candidate to enable cost-effective deployment of wireless TSNs, especially given increasing data rates supported by standards such as IEEE 802.11ac and 802.11ad which enable Gigabit per second data transmission rates. However, Wi-Fi is primarily a contention-based access system, with inherent randomness with respect to channel access. This randomness makes Wi-Fi difficult to apply to applications such as TSN which require a guarantee with respect to bounded latencies.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a Wi-Fi Basic Service Set (BSS) in accordance with some demonstrative embodiments;

FIG. 2 illustrates a radio system of a STA or an AP from the BSS of FIG. 1 in accordance with some demonstrative embodiments;

FIG. 3 illustrates a flowchart of a decision tree on the STA side involving a transmission of a TSN frame according to one embodiment;

FIG. 4 illustrates a flowchart of a decision tree that is a continuation of the decision tree of FIG. 3, and involving preemption of an ongoing downlink frame transmission along with transmission of a TSN frame according to one embodiment;

FIG. 5 illustrates a flowchart of a decision tree on the AP side involving preemption of an ongoing downlink frame transmission or full duplex, along with reception of a TSN frame, according to one embodiment;

FIGS. 6a is a signaling diagram showing frame exchanges between the devices in FIG. 1 according to one embodiment;

FIG. 6b is a signaling diagram similar to FIG. 6a, showing frame exchanges between the devices in FIG. 1 according to another embodiment;

FIG. 6c is a signaling diagram similar to FIGS. 6a and 6b, showing frame exchanges between the devices in FIG. 1 according to yet another embodiment;

FIG. 7 illustrates a flow-chart of a first method according to some demonstrative embodiments;

FIG. 8 illustrates a flow-chart of a second method according to some demonstrative embodiments;

FIG. 9 illustrates a product of manufacture in accordance with some demonstrative embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some demonstrative embodiments may be included in, or substituted for, those of other embodiments. Embodiments set forth in the claims encompass all available equivalents of those claims.

TSN applications include a mix of traffic patterns and requirements, for example from critical synchronous data flows (e.g. from sensor to a controller in a closed loop control system), to asynchronous events (e.g. a sensor detecting an anomaly in the monitored process and sending a report to a controller soon thereafter), to video streaming for remote asset monitoring and background Information Technology (IT) and office traffic. Some TSN requirements may be summarized as follows: (1) precise time synchronization, from the nanosecond (ns or nsec) to the millisecond (ms or msec) range, although 1 microsecond (μsec) is expected to enable most TSN applications (or for example, from 10 μsec to 10 msec, with 1 msec being a good target for the majority of applications); (2) deterministic/bounded end-to-end delivery latency, with maximum and minimum latency from source to destination defined (for example, a maximum latency allowed in the latency ranges provided above, along with a maximum allowed jitter of 10 μsec), keeping in mind that average, mean or typical values would be of no interest; (3) extremely low packet loss probability, such as, for example, a packet loss probability lower than about 10⁻⁵, which requires highly reliable links and devices; and (4) convergence, with sufficient capacity for critical streams and other traffic on a single network.

Keeping the above in mind, wired connectivity for TSN applications, such as, for example, Automotive and Industrial IoT verticals, can require excessive cost maintenance, as TSN applications typically involve real time closed loop control of fast-moving or rotating objects that may require complicated wiring. In addition, future industrial environments, such as smart factories, will require flexible reconfiguration of equipment and mobile devices which would make the use of wired connectivity impractical. Therefore, there are several benefits to enabling TSN-grade performance over wireless networks, that is, over Wireless TSN (WTSN). As noted previously, cellular standards currently do not provide the speed or capacity to meet the requirements of TSN applications. Wi-Fi is a potential candidate to enable cost-effective deployment of WTSN in the industrial vertical, given the increasing data rates supported in Wi-Fi. WTSN mechanisms are therefore needed that allow meeting the requirements of TSN applications.

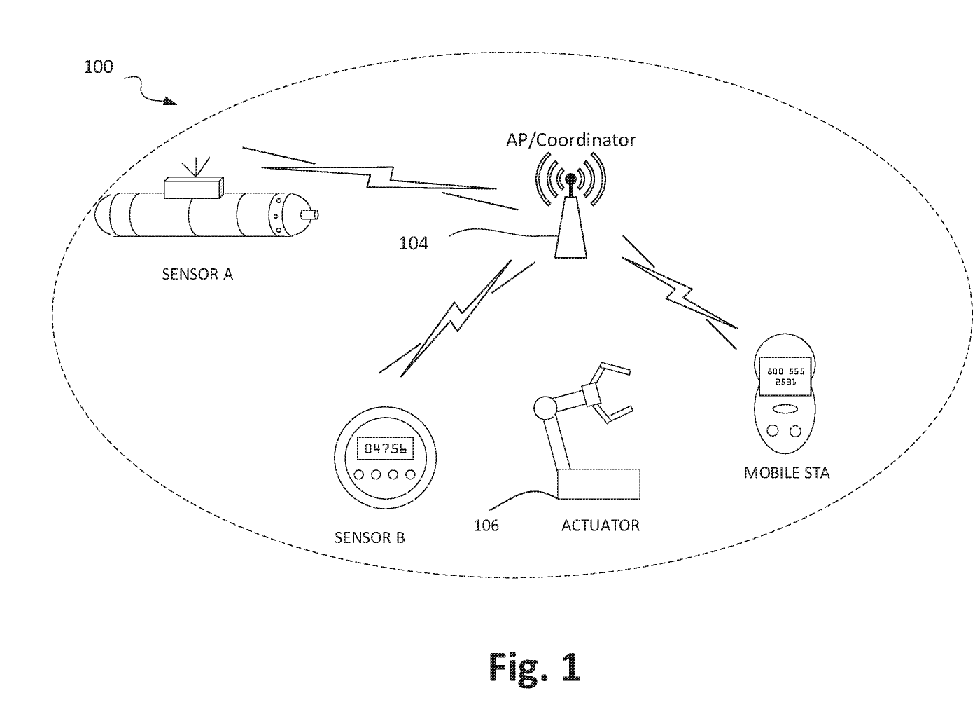

Embodiments will be described below with respect to FIGS. 1-9 to enable efficient TSN frame transmission in a Wi-Fi network.

FIG. 1 is a diagram illustrating an example network environment, such as a BSS, according to some demonstrative embodiments. Wireless network 100 may include one or more wireless stations (STAs) including a Sensor A, a Sensor B, an actuator 106 and a Mobile STA, and, in addition, one or more access point(s) AP, such as AP 104, which may communicate in accordance with various communication standards and protocols, such as, Wi-Fi, IEEE 802.15.4 low-rate Wireless Personal Area Networks (WPAN), Wireless Universal Serial Bus, Wi-Fi Peer-to-Peer (P2P), Bluetooth, Near Field Communication, or any other communication standard. The STAs may all include mobile devices that are non-stationary (e.g., not having fixed locations) or may they may be stationary devices. The STAs as shown in FIG. 1 may include IoT devices, such as sensors, actuators, gauges and mobile devices as a few examples. For example, Sensor A and Sensor B may include TSN-capable STAs, that is, STAs capable of communicating TSN frames.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include slot phones, desktop computers, laptop computers, tablet computers, personal digital assistants (PDAs), etc.

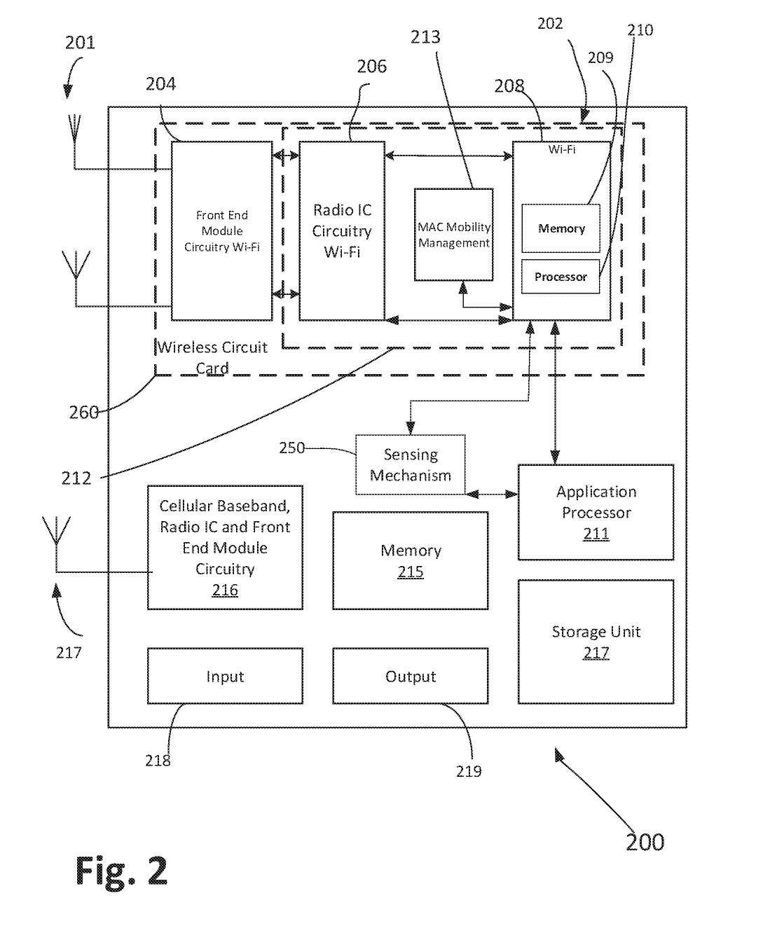

In some embodiments, the STAs and AP 104 of FIG. 1 may include one or more systems similar to that of the radio system shown by way of example in FIG. 2 to be described further below. The STA and/or AP of FIG. 1 may also include mesh stations in, for example, a mesh network, in accordance with one or more IEEE 802.11 standards and/or 3GPP standard, or higher layer standards (such as, for example, a network layer standard) managed by the Internet Engineering Task Force (IETF) community, such as, for example, the Routing Protocol for Low power and Lossy Networks (RPL) routing standard. Any of the STAs and AP of FIG. 1 may be configured to communicate with each other via one or more communications networks. The STAs of FIG. 1 may also communicate directly with each other without the intermediary of AP 104 (in a P2P fashion).

Considering the BSS of FIG. 1, Sensor A and Sensor B may send data flows to the AP, which may control the shown actuator 106 in a closed loop system. A closed loop system is a control system where a controller receives information from a sensor and decides on an actuation action based on the sensor information. The controller then transmits the action to an actuator device. Such systems are used in many industrial processes, such as motion control, motor control, robot control, etc. These are synchronous systems, which means that the data transmissions and compute tasks are executed at specific times in a periodic fashion, e.g., sensors data is sent to controller, which processes and send action command to actuator and the cycle repeats. The closed loop system would require TSN grade performance, that is, it would entail requirements (1)-(4) for TSN applications noted above. However, Sensor A and Sensor B operate in the same BSS as the Wi-Fi Mobile STA, which would be used for Best-Efforts (BE) access category traffic in the BSS. According to a typical channel access procedure as dictated by the Medium Access Control (MAC) mechanisms in IEEE 802.11, the STAs in the BSS must contend for the wireless channel prior to transmitting. In the example of FIG. 1, AP 104 may acquire the channel and may begin sending a downlink frame to the Mobile STA when Sensor B generates a TSN frame including data to send to the AP, with guaranteed low latency. Since the AP is already transmitting the downlink frame however, Sensor B would, under the existing MAC mechanisms of IEEE 802.11, detect the channel as busy, backoff, and contend for the channel again later. The contention based channel access mechanism in the 802.11 MAC in this way introduces a potential random-access delay, which is not compatible with the bounded latency requirements of TSN grade traffic. Even the highest Enhanced Distributed Channel Access (EDCA) parameters, defined in the IEEE 802.11 MAC, could not provide the deterministic channel access required by TSN grade traffic. In addition, it is to be noted that the random-access delay noted above may be accentuated when frame aggregation is being used.

Referring still to FIG. 1, random channel access delays as noted above could be significantly reduced if the AP had full duplex capabilities according to some embodiments, as it could start receiving a TSN frame from Sensor B while continuing transmission of a downlink frame to the Mobile STA in appropriate circumstances. In addition, the random channel access delays could be significantly reduced if Sensor B could, according to some embodiments, preempt transmission of the downlink frame and transmit its high priority TSN frame in appropriate circumstances. By “preemption” in the context of a transmission, what is meant in the instant description is a forestalling or stopping of that transmission in favor of another transmission. Preemption may interfere with the transmission of high priority traffic such as a high priority downlink frame, and it may be desirable for Sensor B to start an uplink TSN frame transmission during a downlink BE frame transmission only after having identified that transmission of its TSN frame would not cause harmful interference as noted above. For example, referring still to FIG. 1, in case the ongoing downlink frame transmission is for example an actuation command from the AP 104 to the actuator 106 (a high priority STA), the potential interference from the uplink transmission of the TSN frame from Sensor B to AP 104 may not be acceptable.

Several technical problems are addressed by embodiment in order to leverage full duplex capabilities of an AP and preemption capabilities within a wireless network to reduce uplink channel access latency for TSN-grade traffic. First, according to some embodiments, a STA may decide when preemption of an ongoing downlink frame transmission by an AP would be required and feasible for a given TSN, and may adapt its channel access behavior to enable preemption. Second, a STA may be able to identify a priority for the ongoing downlink frame transmission. Third, a STA may estimate a probability of interference by initiating a preemptive TSN frame transmission, and may take action to mitigate such interference, such as by delaying the TSN frame transmission. Some embodiments therefore provide a wireless device, such as a STA or a component of a STA, to identify a priority level of ongoing downlink frame transmission, for example using a new Traffic Identifier (TID) or Access Category (AC) to identify a TSN grade frame. Some embodiments further provide a preemption decision procedure to be used by a wireless device, such as a STA, an AP, or a component of a STA or an AP, based on a combination of traffic priority, latency requirements and estimation of interference probability as between a downlink frame and a TSN frame. In addition, some embodiments further provide a mechanism for a wireless device such as a STA or a component of a STA, to ignore its Network Allocation Vector (NAV) to initiate preemption of an ongoing downlink frame transmission by an AP.

Advantageously, embodiments enable reduction of contention based channel access latencies inherent in IEEE 802.11 network in order to support high priority TSN transmission flows. Some embodiments achieve the above by leveraging full duplex capabilities at the AP, or by allowing preemption of Wi-Fi downlink frame transmissions by the AP in order to transmit a TSN frame to the AP. Embodiments contribute to increasing overall network efficiency as the AP would, by virtue of its full duplex capabilities, enable overlapping transmission of background and TSN data as long as interference can be avoided to high priority transmissions. Another advantage of embodiments is that, to the extent APs are complex and more expensive devices, it would be more feasible to enable full duplex on the AP side, while the STA side would remain cost effective at half duplex with lower hardware complexity.

For the instant description of embodiments, it will be assumed that TSN traffic has the highest priority of any other traffic in a network. TSN traffic/frames as referred to herein encompass not only TSN traffic/frames compliant with the IEEE 802.1 TSN set of protocols, but also to any traffic/frames having requirements comparable to those of IEEE 802.1 compliant TSN frames, such as those noted above, namely: (1) precise time synchronization, from the nanosecond (ns) to the millisecond (ms) range, such as about 1 microsecond (μsec) (or for example, from 10 μsec to 10 msec, with 1 msec being a good target for the majority of applications); (2) deterministic/bounded end-to-end delivery latency, with maximum and minimum latency from source to destination defined (for example, a maximum latency allowed in the latency ranges provided above, along with a maximum allowed jitter of 10 μsec), keeping in mind that average, mean or typical values would be of no interest; (3) extremely low packet loss probability, such as, for example, a packet loss probability lower than about 10⁻⁵, which requires highly reliable links and devices; and (4) convergence, with sufficient capacity for critical streams and other traffic on a single network.

Reference will now be made to FIG. 2, which depicts one embodiment of radio system 200 such as one embodiment of a STA, or one embodiment of a AP, such as the APs, or STA shown in FIG. 1. At certain points within the below description, FIG. 2 will be described in reference to a system such as a STA, while at certain other points within the below description, FIG. 2 will be described in reference to a system such as an AP. The context will however be clear based on the description being provided. Furthermore, in the instant description, “processor” and “processing circuitry” are used interchangeably, and refer to circuitry forming one or more processor “blocks” that provides processing functionality.

Referring next to FIG. 2, a block diagram is shown of a wireless communication radio system 200 such as a STA or AP (hereinafter STA/AP) such as the STAs the AP of FIG. 1, according to some demonstrative embodiments. A wireless communication system may include a radio card 202 in accordance with some demonstrative embodiments. Radio card 202 may include radio front-end module (FEM) circuitry 204, radio IC circuitry 206 and baseband processor 208. The block diagram of FIG. 2 is meant to provide a description of only one examples of many different radio systems that may be used to carry out operations according to embodiments, and is not meant to be limiting in any way. For example, although the radio system in FIG. 2 is shown to include multiple radios, including Wi-Fi and cellular, embodiments could encompass a simple architecture including Wi-Fi capability and a sensing mechanism without many of the other components shown in FIG. 2. In FIG. 2, it is to be noted that the representation of a single antenna may be interpreted to mean one or more antennas.

FEM circuitry 204 may include Wi-Fi functionality, and may include receive signal path comprising circuitry configured to operate on Wi-Fi signals received from one or more antennas 201, to amplify the received signals and to provide the amplified versions of the received signals to the radio IC circuitry 206 for further processing. FEM circuitry 204 may also include a transmit signal path which may include circuitry configured to amplify signals provided by the radio IC circuitry 206 for wireless transmission by one or more of the antennas 201. The antennas may include directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Radio IC circuitry 206 may include Wi-Fi functionality, and may include a receive signal path which may include circuitry to down-convert signals received from the FEM circuitry 204 and provide baseband signals to baseband processor 208. The radio IC circuitry 206 may also include a transmit signal path which may include circuitry to up-convert baseband signals provided by the baseband processor 208 and provide RF output signals to the FEM circuitry 204 for subsequent wireless transmission by the one or more antennas 201.

Baseband processor 208 may include processing circuitry that provides Wi-Fi functionality. In the instant description, the baseband processor 208 may include a memory 209, such as, for example, a set of RAM arrays in a Fast Fourier Transform or Inverse Fast Fourier Transform block (not shown) of the baseband processor 208. Processing circuitry 210 may include control logic to process the signals received from the receive signal path of the radio IC circuitry 206. Baseband processor 208 is also configured to also generate corresponding baseband signals for the transmit signal path of the radio IC circuitry 206, and may further include physical layer (PHY) and medium access control layer (MAC) circuitry, and may further interface with application processor 211 for generation and processing of the baseband signals and for controlling operations of the radio IC circuitry 206. Referring still to FIG. 2, according to the shown embodiment, a MAC mobility management processor 213 may include a processor having logic to provide a number of higher MAC functionalities. In the alternative, or in conjunction with the MAC mobility management processor 213, some of the higher-level MAC functionalities above may be provided by application processor 211.

In some demonstrative embodiments, the front-end module circuitry 204, the radio IC circuitry 206, and baseband processor 208 may be provided on a single radio card, such as wireless radio card 202. In some other embodiments, the one or more antennas 201, the FEM circuitry 204 and the radio IC circuitry 206 may be provided on discrete/separate cards or platforms. In some other embodiments, the radio IC circuitry 206 and the baseband processor 208 may be provided on a single chip or integrated circuit (IC), such as IC 212.

In some demonstrative embodiments, the wireless radio card 202 may include a Wi-Fi radio card and may be configured for Wi-Fi communications, although the scope of the embodiments is not limited in this respect. In some other embodiments, the radio card 202 may be configured to transmit and receive signals transmitted using one or more modulation techniques other than OFDM or OFDMA, such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, and On-Off Keying (OOK), although the scope of the embodiments is not limited in this respect.

In some demonstrative embodiments, the system 200 may include other radio cards, such as a cellular radio card in the form of Cellular Baseband, Radio IC and Front End Module Circuitry 216 configured for cellular communication (e.g., 3GPP such as LTE, LTE-Advanced or 5G communications).

In some IEEE 802.11 embodiments, the radio card 202 may be configured for communication over various channel bandwidths including bandwidths having center frequencies of 900 MHz, 2.4 GHz, 5 GHz, and bandwidths of lower than 5 MHz, or of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths), or any combination of the above frequencies or bandwidths, or any frequencies or bandwidths between the ones expressly noted above. In some demonstrative embodiments, a 320 MHz channel bandwidth may be used. The scope of the embodiments is not limited with respect to the above center frequencies however.

Referring still to FIG. 2, in some demonstrative embodiments, STA/AP may further include an input unit 218, an output unit 219, a memory unit 215. STA/AP may optionally include other suitable hardware components and/or software components. In some demonstrative embodiments, some or all of the components of STA/AP may be enclosed in a common housing or packaging, and may be interconnected or operably associated using one or more wired or wireless links. In other embodiments, components of STA/AP may be distributed among multiple or separate devices.

In some demonstrative embodiments, application processor 211 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Application processor 211 may execute instructions, for example, of an Operating System (OS) of STA/AP and/or of one or more suitable applications.

In some demonstrative embodiments, input unit 218 may include, for example, one or more input pins on a circuit board, a keyboard, a keypad, a mouse, a touch-screen, a touch-pad, a track-ball, a stylus, a microphone, or other suitable pointing device or input device. Output unit 219 may include, for example, one or more output pins on a circuit board, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory 215 may include, for example, a Random-Access Memory (RAM), a Read-Only Memory (ROM), a Dynamic RAM (DRAM), a Synchronous DRAM (SD-RAM), a flash memory, a volatile memory, a non-volatile memory, a cache memory, a buffer, a short-term memory unit, a long-term memory unit, or other suitable memory units. Storage unit 217 may include, for example, a hard disk drive, a floppy disk drive, a Compact Disk (CD) drive, a CD-ROM drive, a DVD drive, or other suitable removable or non-removable storage units. Memory unit 215 and/or storage unit 217, for example, may store data processed by STA/AP.

The system 200 may further include a sensing mechanism/location engine 250, which may be coupled to the baseband processor 208 and application processor 211, and which may be configured to detect information regarding a location of the system 200. The location engine may include either dedicated processing circuitry including logic to allow a determination of location information, or it may include logic that is embedded within the application processor 211 (not shown). The location information/information regarding a location of the system may include information indicating location (latitude, longitude and/or altitude for either a current location or an estimated target location), direction of movement, speed of movement, acceleration, etc. The location engine may include functionality of a compass, an accelerometer, a gyroscope, a Global Positioning System (GPS), for example in combination, which together may tell the system its speed and direction, as would be recognized by one skilled in the art.

Throughout the instant description, reference will be made at times to a wireless communication device. According to embodiments, a wireless communication device may encompass some or all of a radio system, such as system 200 of FIG. 2. For example, a wireless communication device according to embodiments may encompass a baseband processor, such as baseband processor 208 of FIG. 2, or it may encompass an integrated circuit including a baseband processor such as baseband processor 208 along with a radio IC circuitry, such as radio IC circuitry 206 of FIG. 2, or it may encompass a wireless circuit card such as wireless circuit card 260, or it may include any system which includes a baseband processor, such as the radio system 200 of FIG. 2, and such as a STA or an AP.

As used in this disclosure, when “at least one of” a given set or list of items connected with “and” is mentioned herein, what is meant is a reference to either one of the noted items, or any combination of the items. For example, as used herein, “at least one of A, B and C” means “A, or B, or C, or A and B, or A and C, or B and C, or A and B and C.”

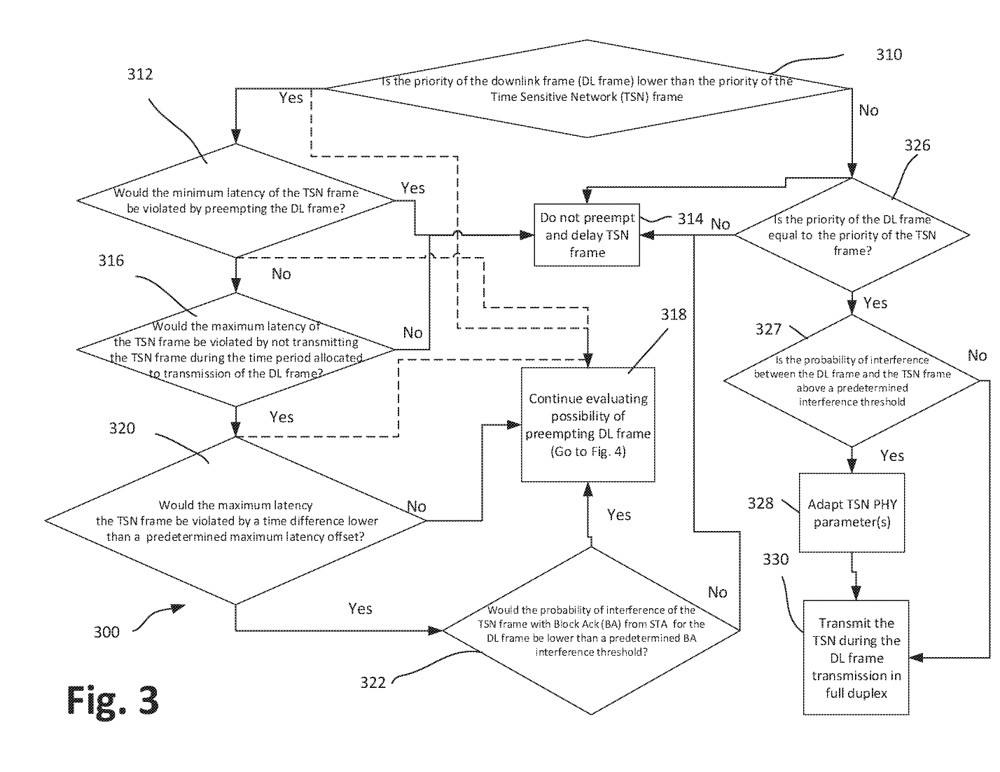

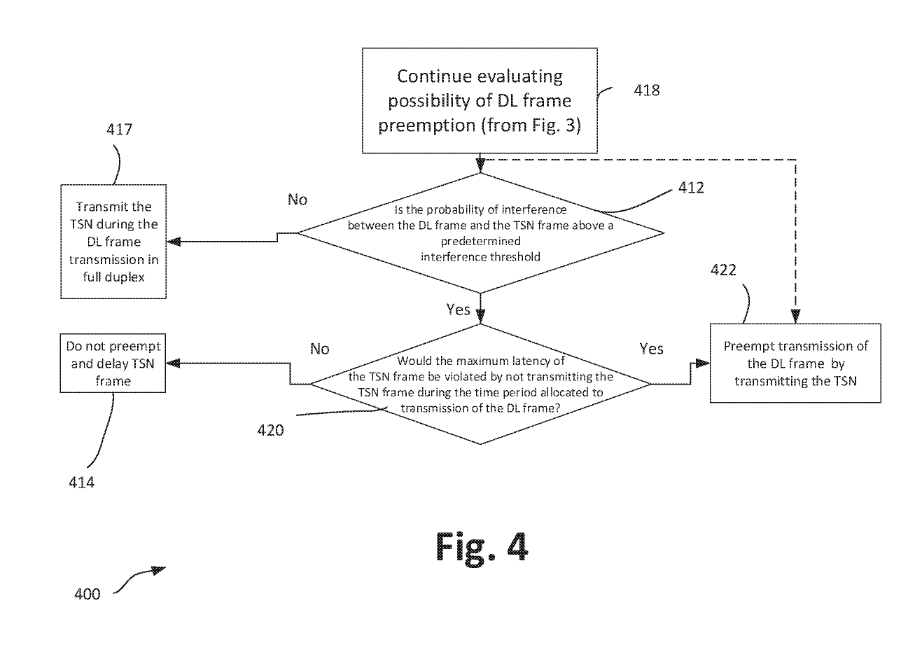

Reference is now made to FIG. 3, which shows a flowchart of a decision tree 300 involving evaluation of a transmission of a TSN frame by a wireless communication device on the STA side according to one embodiment. According to some embodiments, the decision tree of FIG. 3 may be followed by a wireless communication device on the STA side for example by a wireless communication device on the side of a sensor, such as Sensor B of FIG. 1. The decision tree of FIG. 3 illustrates decision nodes 310, 312, 316, 320, 322, 326 and 327 which denote queries that a wireless communication device with a TSN frame to be transmitted may make according to embodiments in order to determine answers that would ultimately allow it to decide whether to avoid preemption of the DL frame and delay transmission of the TSN frame, or whether to further evaluate the possibility of downlink frame preemption. A STA side wireless communication device, according to the embodiment of FIG. 1, may determine, at node 310, whether the priority of the downlink frame transmission is lower than a priority of the TSN frame. The priority of the DL frame transmission may be communicated within the DL frame transmission, such as for example in the Quality of Service (QoS) Control field of the same. In order to identify the priority level of on-going DL transmission, the STA may need to look into the QoS Control field in the MAC header and compare the priority level of the on-going DL traffic with its TSN transmission. If the on-going DL transmission is also a TSN-grade transmission (such as from an AP sending a command to an actuator), then the on-going TSN-grade downlink transmission may have a higher priority, and should either not be preempted, or not subjected to interference, unless otherwise indicated by the AP.

If the wireless communication device determines that the downlink frame has a lower priority than the TSN frame at 310, the wireless communication device could, according to one embodiment, immediately move to 318 to continue evaluating the possibility of preemption of the downlink frame, which process will be explained in further detail in FIG. 4. In addition, if the wireless communication device determines that the downlink frame has a lower priority than the TSN frame at 310, the wireless communication device could, according to an alternative preferred embodiment, move to node 312, where it would determine whether transmitting the TSN frame duration a time allocated to the transmission of the downlink frame would violate the TSN frame's minimum latency requirements. Examples of minimum latency requirements for TSN frames have been provided previously. If the minimum latency requirements of the TSN frame would be violated by transmitting the TSN frame during a time period allocated to transmission of the downlink frame, the wireless communication device may delay the TSN transmission and refrain from preempting the DL frame at 314. If the minimum latency requirements of the TSN frame would not be violated by transmitting the TSN frame during a time period allocated to transmission of the downlink frame, the wireless communication device would then move to node 316, where the wireless communication device would determine whether a maximum latency of the TSN frame would be violated by not transmitting the TSN frame during a time period allocated to transmission of the downlink frame (i.e. whether the maximum latency of the TSN frame would be violated by either not preempting the downlink frame and transmitting the TSN frame, or by not transmitting the TSN frame in full duplex along with transmission of the downlink frame by the AP). It is to be noted that the time period allocated to transmission of the downlink frame would correspond to the duration of the downlink frame as for example transmitted in its header field. Examples of maximum latency requirements for TSN frames have been provided previously. The wireless communication device may determine an answer for the question in decision node 316, that is, the question of whether the maximum latency of the TSN frame would be violated by not transmitting the TSN frame during a time period allocated to transmission of the downlink frame, for example by checking whether the remaining transmission time for the downlink frame at the time when the TSN frame could be transmitted would be greater than a given/predetermined maximum time threshold or difference allowed for the TSN frame. If the answer to the question in decision node 316 is no, the wireless communication device may refrain from preempting the downlink frame transmission, and may delay transmission of the TSN frame until after transmission of the downlink frame, because a negative difference between the remaining transmission time for the downlink frame and the maximum latency allowed for the TSN frame would suggest that the TSN frame could be sent after the downlink frame. However, if the answer to the question in decision node 316 is yes, then the wireless communication device may move to decision node 320. At 320, the wireless communication device may evaluate the extent to which the maximum latency of the TSN frame would be violated. Specifically, the wireless communication device at node 320 may determine whether the maximum latency of the TSN frame would be violated by a time difference lower than a predetermined maximum latency threshold time difference. Practical ranges for the predetermined maximum latency threshold time difference according to embodiments may depend on applications and target end-to-end latency requirements. By way of example, tens of microseconds (or up to about 200 μsec in some cases), or about 5% of the end-to-end latency requirement may represent typical predetermined maximum latency threshold time difference values.

According to the embodiment as suggested in decision node 320, the wireless communication device would be determining if there is only a small portion of the downlink frame remaining to be transmitted. If the answer to the question in decision node 320 is no, then the wireless communication device may move to 318 to continue evaluating the possibility of preemption. However, if the answer to the question in decision node 320 is yes, then only a small part of the ongoing downlink frame transmission would be left, and the wireless communication device may move to decision node 322, where it may evaluate the probability of frame collision between a Block Acknowledgment (BA) (from a recipient STA of the downlink frame) and a TSN frame transmission should the downlink frame be preempted. In order to determine a probability of frame collision as noted above, the AP may probe the STAs to create an interference map between the recipient STAs and the destination station for the TSN, this map for example being a function of a location of each STA. The AP may create this interference map as a matter of course and independently of the preemption decision process flow. In the alternative, the wireless communication device may know when the on-going DL transmission will end followed by the BA transmission, and may in this way be able to evaluate the possibility of the TSN frame being subjected to interference by the DL BA frame transmission. The probability of frame collision between a BA and a TSN frame transmission may come into play since, even in the event of a preemption of the downlink frame in order to transmit the TSN frame, the recipient STA may still proceed to send the BA at the end of the expected time period for the transmission of the downlink frame, not being aware of a preemption. If the probability of interference with a BA from a STA that is a recipient of the downlink frame to the AP that sent the downlink frame is lower than a predetermined BA interference threshold, this would mean that there is only a small probability of collision of the BA with a TSN frame if the downlink frame were to be preempted. In such a case, the wireless communication device may move to 318 and continue evaluating the possibility of preemption. If the answer to the question in node 322 is no, however, this would mean that there is relatively high probability of collision of the BA with a TSN frame if the downlink frame were to be preempted. In such a case, the wireless communication device may move to 314 to refrain from preempting the downlink frame and delay transmission of the TSN frame. The predetermined BA interference threshold may, according to embodiments, be based on application needs. For example, the predetermined BA interference threshold may be less than about 5% of the TSN frame error rate due to the interference caused by the downlink BA frame may be typical in some applications.

Moreover, even if there is a possibility for a TSN frame being interfered with by a BA frame, according to one embodiment, the recipient of the BA frame, such as an AP, may be able to (i) successfully decode the BA frame if the AP's receiver chain locks into the BA frame, and (ii) successfully transmit the TSN frame if the interference from the BA frame transmission is not large enough to disrupt the on-going TSN frame decoding. All of the above factors may be considered in evaluating the collision probability (or the BA interference throughput) in 322.

Referring still to FIG. 3, and specifically again to decision node 310, if the wireless communication device determines that the priority of the downlink frame is not lower than the priority of the TSN frame, the wireless communication device may move to decision node 326, where it would determine whether the downlink frame has a priority equal to the priority of the TSN frame about to be transmitted (for example, when the downlink frame is itself a TSN frame). If the answer to the question in decision node 326 is yes, then the wireless communication device may either refrain from preempting and delay transmission of the TSN frame (not shown), or, it may move to decision node 327 to determine whether the probability of interference between the TSN frame and the downlink frame is above a predetermined interference threshold. According to some embodiments, the wireless communication device may estimate a probability of interference between the TSN frame and the downlink frame based on several options, for example by evaluating link measurements between neighboring STAs, using an interference map as provided for example by the AP, or any other mechanism as would be within the knowledge of a skilled person. If the answer to question 327 is yes, then the wireless communication device may move to 328 to adapt one or more PHY parameters of the TSN transmission, such as, for example, lowering its transmission power, or changing the Modulation and Coding Scheme for the transmission (MCS) (for example, for a shorter latency budget, using a higher MCS to send the transmission more quickly, and for a transmission where reliability has more priority, using a lower MCS), or changing any other well-known PHY parameter of the transmission and then move onto 330 to transmit the modified TSN frame at the same time that the downlink frame is being transmitted, that is, in full duplex with respect to the AP. If the answer to the question in decision node 326 is no, then the wireless communication device would know that the priority of the downlink frame is higher than the priority of the TSN frame, and may move to 314 where it would refrain from preemption and delay transmission of the TSN frame. On the other hand, if the answer to the question in decision node 327 is no, then the wireless communication device may move to 330 to transmit the modified TSN frame at the same time that the downlink frame is being transmitted, that is, in full duplex with respect to the AP, knowing that there would be a very low chance of interference.

Referring still to FIG. 3, it is to be noted that, at any appropriate point in the decision tree 300 of FIG. 3, the wireless communication device may decide to dispense with further decision nodes, and move to continue evaluating the possibility of preemption at 318. For example, as shown in broken lines in FIG. 3, if the answer to the question in decision node 310 is yes (if the priority of the downlink frame is lower than the priority of the TSN frame), if the answer to the question in decision node 312 is no (if minimum latency requirements of the TSN frame would not be violated by transmitting the TSN frame during a time period allocated to transmission of the downlink frame), if the answer to the question in decision node 316 is yes (if the maximum latency of the TSN frame would be violated by not transmitting the TSN frame during a time period allocated to transmission of the downlink frame), then the wireless communication device may move directly to 318 to begin evaluating the possibility of preemption, or (not shown) the wireless communication device may begin preemption of the downlink frame per 422 in FIG. 4. In addition, although FIG. 3 suggests an order for the shown decision nodes, embodiments are not so limited, and may include any reasonable order for the decision nodes, such as, for example, an evaluation of a possible violation of the maximum latency of the TSN frame prior to an evaluation of a possible violation of the minimum latency of the TSN frame.

With respect to comparing respective priorities of the downlink frame and of the TSN frame, the wireless communication device may, according to one embodiment, decode an IEEE 802.11 MAC header of the downlink frame with reserved bits for a Traffic Identifier (TID) or Access Category (AC). There are currently four access categories defined for EDCA, and those include: AC_BE (with a value of 0 to indicate a Best Effort AC), AC_BK (with a value of 1 to indicate a Background AC), AC_VI (with a value of 2 to indicate a Video AC) and AC_VO (with a value of 3 to indicate a Voice AC). Embodiments envisage using an AC_TSN category (with a value of 4 to indicate a TSN AC). The reserved bits may for example be in a Quality of Service (QoS) Control field with 3 reserved bits for the TID and AC. The wireless communication device may therefore know the priority of the downlink frame, and compare the same to the priority of the TSN frame generated by it for transmission in order to determine an answer to the question in node 310 of FIG. 3. Where multiple TSN frames are to be considered, the TSN AC category may be used in conjunction with other parameters, such as with the latency deadline of each TSN frame to be transmitted, with the smallest latency budget having the highest priority. In addition, with respect to answering the queries of nodes 316 and 320 as to whether and by how much the maximum latency of the TSN frame may be violated by not transmitting the TSN frame during a time period allocated to transmission of the downlink frame, the wireless communication device may decode duration information in the header of the downlink frame, such as, for example, through a Legacy Signal (L-SIG) portion of the header of the downlink frame, and set its Network Allocation Vector (NAV) accordingly, and thereafter use the duration information for any subsequent preemption decisions and/or decisions involving transmitting the TSN frame.

FIG. 4 illustrates a flowchart of a decision tree 400 involving continuing evaluation of a possible preemption of an ongoing downlink frame transmission along with transmission of a TSN frame, as suggested for example by box 318 in FIG. 3 or 418 in FIG. 4, according to one embodiment. FIG. 4 is therefore a continuation of FIG. 3, and involves a further question at decision node 412 as to whether a probability of interference between the downlink frame and the TSN frame is above a downlink frame predetermined interference threshold. The downlink frame predetermined interference threshold is a parameter that may be based on application needs. For example, a DL frame predetermined interference threshold of less than about 5% of the TSN frame error rate due to the interference caused by the downlink frame may be typical in some applications. A wireless communication device may always, according to one embodiment as shown by broken lines in FIG. 4, proceed with preemption of a lower priority frame regardless of potential interference. As seen in FIG. 4, if the wireless communication device determines after answering the question in decision node 412 that the probability of interference between the downlink frame and the TSN frame is not above the downlink frame predetermined interference threshold, the wireless communication device may move to 417 and transmit the TSN frame during the downlink frame transmission. In doing so, the wireless communication device may take advantage of full duplex capabilities of the AP. However, the wireless communication device may, after having determined a low probability of interference between the TSN frame and the downlink frame per question 412, instead of using the full duplex capabilities of the AP, simply preempt the downlink frame (not shown in FIG. 4) and proceed with the TSN transmission. If the wireless communication device determines at node 412 that a probability of interference between the TSN frame and the downlink frame is above the downlink frame predetermined interference threshold, then the wireless communication device may move to decision node 420, where it will determine whether the maximum latency of the TSN frame would be violated by not transmitting the TSN frame during a time period allocated to transmission of the downlink frame. Decision node 420 appears in FIG. 4 for two reasons: (1) in the event that the wireless communication device may not have determined potential violation of maximum latency in decision node 316 in FIG. 3 (for example, by going directly from a yes to the question in 310, or from a no to the question in 312 to 318); and (2) even if the wireless communication device has already determined an answer to the question in decision node 316, because using that answer in the decision tree of FIG. 4 would allow the wireless communication device to make a decision as to whether to move to decision 414 or to decision 422. If the wireless communication device determines that the maximum latency of the TSN frame would be violated by not transmitting the TSN frame during a time period allocated to transmission of the downlink frame, the wireless communication device may move to 422 to preempt transmission of the downlink frame and transmit the TSN frame. If the wireless communication device determines that the maximum latency of the TSN frame would not be violated by not transmitting the TSN frame during a time period allocated to transmission of the downlink frame, the wireless communication device may move to 414 and refrain from preempting the downlink frame, and delay transmission of the TSN frame until after completion of the downlink frame transmission.

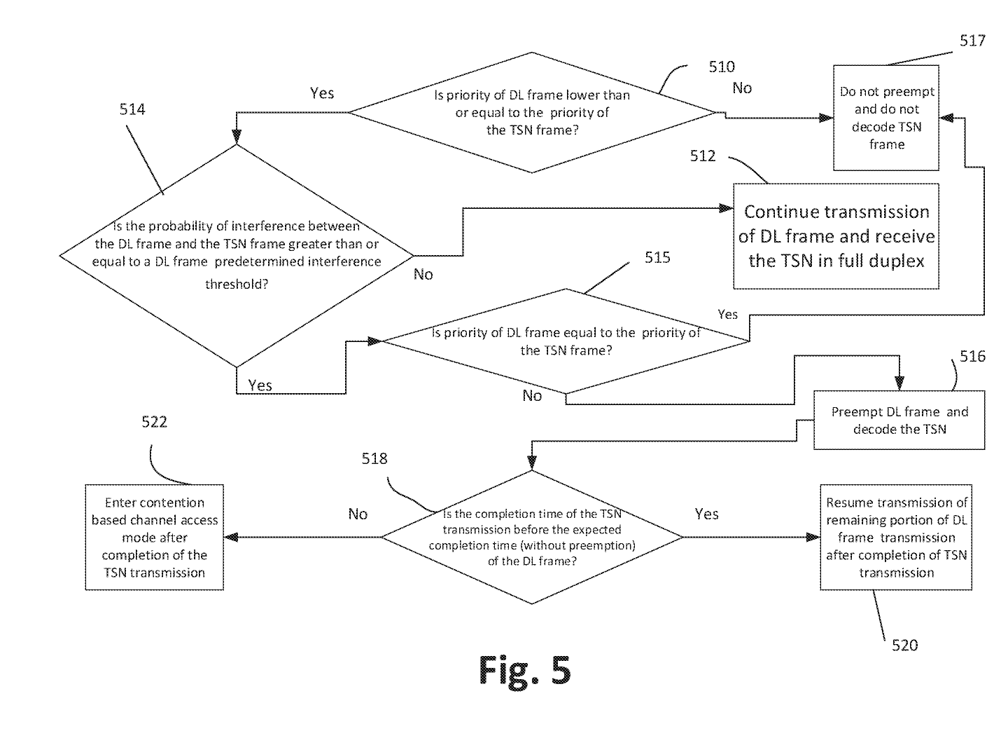

FIG. 5 illustrates a flowchart of a decision tree involving preemption of an ongoing downlink frame transmission or full duplex, along with reception of a TSN frame, according to one embodiment. The decision tree shown in FIG. 5 may be implemented at a wireless communication device on the AP side according to one embodiment. The decision tree of FIG. 5 illustrates decision node 510, 514 and 518 which denote questions that a wireless communication device on the AP side may pose according to embodiments in order to determine whether and how to preempt the transmission of a downlink frame, and whether to receive a TSN frame in full duplex along with the downlink frame transmission.

Referring to FIG. 5, at decision node 510, the wireless communication device may determine whether the priority of the downlink frame is lower than or equal to the priority of the TSN frame. In order to address the question in decision node 510, the wireless communication device on the STA side may, according to one embodiment, differentiate the critical TSN frame from all other traffic by defining a new access category AC or priority level for the TSN frame. For example, a new AC category and associated value could be defined for TSN data flow, such as AC_TS (with a value of 4 to indicate a TSN transmission or frame), and included in the header of the TSN transmission, for every frame that requires a TSN-grade QoS. In this manner, when receiving the TSN frame, the wireless communication device on the AP side would be able to decode the frame header, such as a MAC header including the AC value, and be able to compare the same with the priority of the AC for the downlink frame it is transmitting in order to determine an answer to the question in decision node 510. If the answer to the question in decision node 510 is yes, then the wireless communication device may determine at decision node 514 whether a probability of interference between the TSN frame and the downlink frame is above a predetermined interference threshold. The predetermined interference threshold may have a value similar to the value of the predetermined interference threshold discussed with respect to decision node 412 in FIG. 4. If the answer to the query in decision node 514 is no, the wireless communication device would know that the probability of interference between the TSN frame and the downlink frame is low, and may continue transmission of the downlink frame and may receive the TSN frame in full duplex at 512. If the answer to the query in decision node 514 is yes, the wireless communication device may determine at decision node 515 whether the priority of the DL frame is equal to that of the TSN frame, and if yes, it may at 517 refrain from preempting the downlink frame and not decode the TSN frame, such as at least the payload portion of the TSN frame. However, if the wireless communication device determines that the answer to the question in query 515 is no, then it may preempt the downlink frame and decode the TSN frame at 516. If the wireless communication device does decide to preempt at 516, it may, at decision node 518, determine whether the completion time of the TSN transmission (as indicated by a duration indication in its header, for example, is before the expected completion time (without preemption) of the downlink frame. The wireless communication device may determine an answer to the question in decision node 518 so that, subsequently, it may cause to transmit only the remainder of the downlink frame (for example, if the downlink frame included an Aggregate Medium Access Control (MAC) Protocol Data Unit (PDU), or A-MPDU, the wireless communication device would cause transmission of the remainder of the MPDU frames instead of retransmitting the entire A-MPDU again after completion of transmission of the TSN frame. If the wireless communication device determines that the completion time of the TSN is not before the expected completion time of the downlink frame (that is, if the wireless communication device determines that the Network Allocation Vector (NAV) value set by the transmission of the downlink frame would have expired at the completion of transmission of the TSN frame), at the completion of the transmission of the TSN frame, it may at 522 enter a contention based channel access mode to regain control of the channel in order to transmit the remaining portion of the downlink frame. However, if, the wireless communication device determines that the completion time of the TSN is before the expected completion time (without preemption) of the downlink frame, then the wireless communication device would know that the NAV value set by transmission of the downlink frame would not have expired after completion of transmission of the TSN frame and would at 520 resume transmission of the remaining portion of the downlink frame transmission after completion of the TSN transmission, for example after an Interframe Space (IFS) time period. If the wireless communication device arrives at 520, other STAs in the network may rest their NAV values based on the resumed downlink frame transmission, or based on detecting the channel busy and deferring their own transmissions. In another embodiment, not shown, the wireless communication device may decide to always preempt the downlink frame transmission as soon as it determines that the downlink frame transmission has a lower priority than the TSN frame in order to minimize a potential of retransmissions.

With respect to embodiments, a wireless communication device on the STA side may explicitly request an AP to preempt an ongoing downlink frame transmission based on its own interference estimations (as opposed to the wireless communication device on the AP side always being involved in making that determination), for example as depicted at decision node 412 in FIG. 4. For example, according to one embodiment, a new 1 bit field may be defined in the MAC header (e.g. a Frame Control Field) of the TSN frame. When set to a certain value, for example to “1,” “0,” or any other predetermined value, the AP would know to preempt the ongoing transmission of the downlink frame to avoid interference from the TSN grade frame transmission. In another embodiment, a new Control Frame may be provided, to be sent by the wireless communication device on the STA side, for example a “Preemption Request” frame, that may have at least one field to indicate whether the AP should preempt ongoing transmission. The wireless communication device on the STA side could cause transmission of such a Preemption Request frame to the AP prior to a transmission of the TSN frame to indicate to the AP that it must preempt the downlink frame transmission.

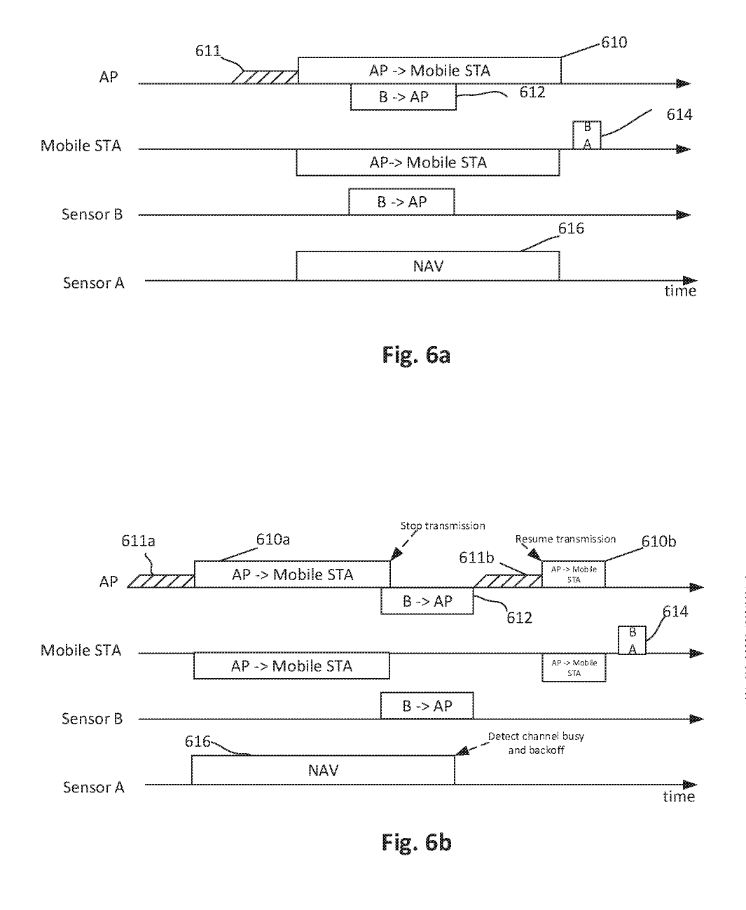

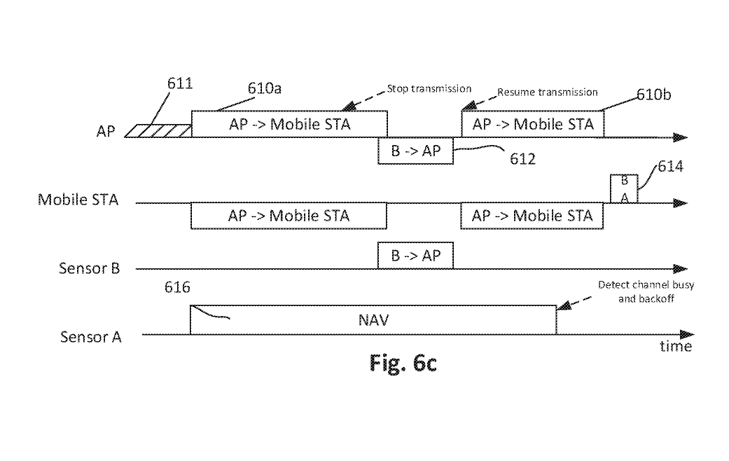

Reference will now be made to FIGS. 6a-6c. FIG. 6a-6c show respective signaling diagrams showing frame exchanges between the devices in FIG. 1 according to some embodiments, with the horizontal direction depicting time. The frame exchanges as shown in FIGS. 6a-6c may be brought about for example using one or more of the decision trees shown and described with respect to FIGS. 3-5 above.

As seen in FIG. 6a, a downlink frame 610 from the AP to the Mobile STA is shown as occupying a given time period, and has having set the NAV 616 such as for Sensor A. the AP is shown as having gone through a contention process by way of the backoff 611 preceding the downlink frame transmission 610. Sensor B is shown as transmitting, at the same time as the transmission of downlink frame 610 from the AP, an uplink TSN frame 612 to the AP. The AP as shown in FIG. 6a is therefore operating in full duplex. The scenario in FIG. 6a may have been brought about for example by way of any of the flows that led to a full duplex scenario as depicted by 330, 417 and 512 in FIGS. 3, 4, and 5 respectively. At the conclusion of the transmission of the downlink frame 610, the Mobile STA is shown as having sent a BA 614 back to the AP.

Referring now to FIG. 6b, the AP is shown as having undergone a contention process by way of backoff 611a, after which it is shown as having transmitted a first portion 610a of a downlink frame to the Mobile STA. The downlink frame is shown as having been preempted by a TSN uplink frame transmission 612 from Sensor B to the AP. The preemption in FIG. 6b may have been brought about for example by way of the flows that led to a preemption scenario as depicted by 422 and 516 in FIGS. 4 and 5 respectively. The downlink frame is shown as having permitted Sensor A to set its NAV 616 for the expected duration of the downlink frame (that is, for the duration of beginning portion 610a of the downlink frame plus the duration of remaining portion 610b of the downlink frame). At the conclusion of the TSN frame 612, the NAV is shown as having already expired, corresponding for example to scenario 522 in FIG. 5. At this time, the AP is shown as entering another contention period by way of backoff 611b to gain access to the channel again in order to transmit the remaining portion 610b of the downlink frame. Although the TSN frame transmission 612 is shown as surpassing the NAV duration, Sensor A would know to detect the air medium busy and backoff by virtue of the presence of the TSN frame over the channel. After the remaining portion 610b of the downlink frame has been transmitted, the Mobile STA is shown as having sent a BA 614 to the AP in the usual manner.

Referring now to FIG. 6c, the AP is shown as having undergone a contention process by way of backoff 611, after which it is shown as having transmitted a first portion 610a of a downlink frame to the Mobile STA. The downlink frame is shown as having been preempted by a TSN uplink frame transmission 612 from Sensor B to the AP. The preemption of FIG. 6b may have been brought about for example by way of the flows that led to a preemption scenario as depicted by 422 and 516 in FIGS. 4 and 5 respectively. The downlink frame is shown as having permitted Sensor A to set its NAV 616 for the expected duration of the downlink frame (that is, for the duration of beginning portion 610a of the downlink frame plus the duration of remaining portion 610b of the downlink frame). At the conclusion of the TSN frame 612, the NAV is shown as still being in force, corresponding for example to scenario 520 in FIG. 5. At this time, the AP is shown as resuming transmission of the remaining portion 610b of the downlink frame without contending for the medium. Although the transmission of the remaining portion 610b of the downlink frame is shown as surpassing the NAV duration, Sensor A would know to detect the air medium busy and backoff by virtue of the presence of the remaining portion 610b of the downlink frame over the channel. After the remaining portion 610b of the downlink frame has been transmitted, the Mobile STA is shown as having sent a BA 614 to the AP in the usual manner.

Reference will now be made to FIGS. 1-6c in order to describe some demonstrative embodiments, although it is to be noted that embodiments are not limited to what is described and shown herein with respect to FIGS. 1-6c, or any of the other figures included herein.

According to some demonstrative embodiments, a wireless communication device, such as a baseband processor 208 within the STA/on the STA side of FIG. 2, may comprise a memory, such as memory 209 of FIG. 2, and processing circuitry, such as processing circuitry 210 of FIG. 2, the processing circuitry being coupled to the memory 209. Memory 209 may include instructions or logic, and the processing circuitry may be configured to implement or perform the instructions or logic. The STA may for example correspond to Sensor B of FIG. 1. The processing circuit may implement the logic to generate a Time Sensitive Network (TSN) frame addressed to a wireless access point, such as to the AP of FIG. 1, and to preempt transmission of a downlink frame being transmitted by the AP and cause transmission of the TSN frame to the access point, as suggested for example by 422, preempting transmission of the downlink frame being in response to a determination that a priority of the downlink frame is lower than a priority of the TSN frame for example by decision node 310 in FIG. 3; and cause transmission of the TSN frame to the access point during transmission of the downlink frame by the access point in full duplex, as suggested for example by 417 in FIG. 4, in response to a determination that the priority of the downlink frame is higher than a priority of the TSN frame, as suggested for example by decision node 412 in FIG. 4.

It is to be noted that, while a processing circuitry according to embodiments may cause transmission, that is, may generate a frame for transmission, the actual transmission itself may be effected by way of the system such as the radio system 20 and antennas 201.

According to some demonstrative embodiments, a wireless communication device, such as a baseband processor 208 within the AP/on the AP side of FIG. 2, may comprise a memory, such as memory 209 of FIG. 2, and processing circuitry, such as processing circuitry 210 of FIG. 2, the processing circuitry being coupled to the memory 209. Memory 209 may include instructions or logic, and the processing circuitry may be configured to implement or perform the instructions or logic. The processing circuit may implement the logic to cause transmission of a downlink frame to a first wireless station, such as, for example, to Mobile STA in FIG. 1, and such as, for example, downlink frame 610a in FIGS. 6a and 6b, and to preempt the downlink frame as shown by way of example in FIGS. 6a and 6b and as suggested by 516 in FIG. 5, and to decode a Time Sensitive Network (TSN) frame, such as frame 612 in FIGS. 6a and 6b, in response to a determination that a priority of the downlink frame is lower than a priority of the TSN frame, as shown by way of example by decision node 510 of FIG. 5.

According some embodiments, the processing circuitry may further be configured to: preempt (as suggested for example by 516 in FIG. 5) the downlink frame, such as downlink frame 610a inn FIGS. 6a and 6b, and to decode the TSN frame in response to a determination that the priority of the downlink frame is lower than the priority of the TSN frame (as suggested for example by decision node 510 in FIG. 5), and to a determination that a probability of interference between the downlink frame and the TSN frame is greater than a predetermined interference threshold (as suggested for example by decision node 514 in FIG. 5); and decode the TSN frame and continue transmission of the downlink frame in full duplex (as suggested for example by 512 in FIG. 5) in response to a determination that a priority of the downlink frame is lower than to a priority of the TSN frame as suggested for example by decision node 510 in FIG. 5), and a determination that a probability of interference between the downlink frame and the TSN frame is lower than the predetermined interference threshold (as suggested for example by 514 in FIG. 5).

According to some embodiments, the memory may encompass memory 209 and/or memory 215, and the processing circuitry may encompass processing circuitry 210 of FIG. 2 and/or application processor 211 of FIG. 2.

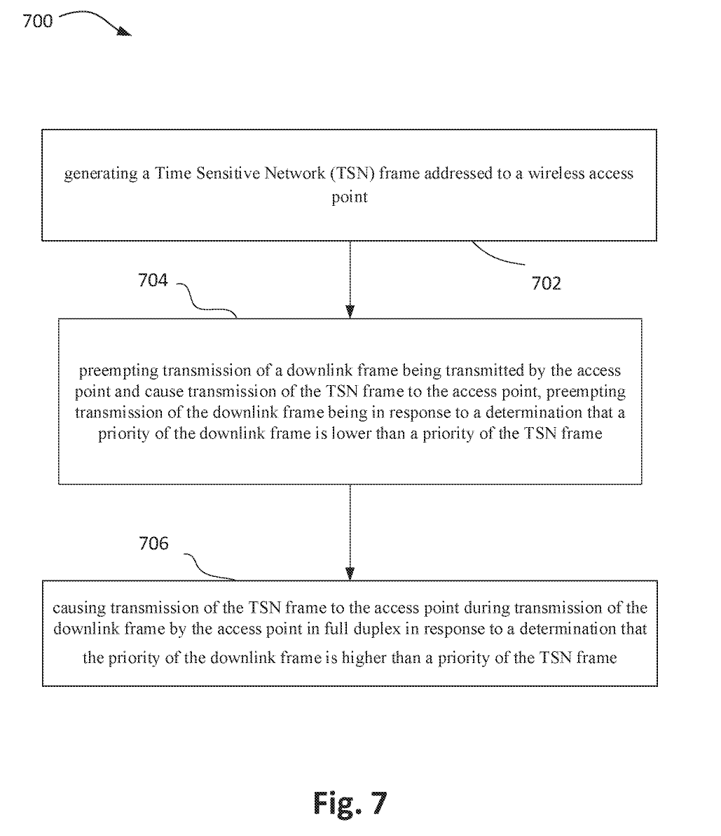

FIG. 7 illustrates a method 700 of operating a wireless communication device according to some demonstrative embodiments. The method 700 may begin with operation 702, which includes generating a Time Sensitive Network (TSN) frame addressed to a wireless access point. At operation 704, the method includes preempting transmission of a downlink frame being transmitted by the access point and cause transmission of the TSN frame to the access point, preempting transmission of the downlink frame being in response to a determination that a priority of the downlink frame is lower than a priority of the TSN frame. Then, at operation 706, the method includes causing transmission of the TSN frame to the access point during transmission of the downlink frame by the access point in full duplex in response to a determination that the priority of the downlink frame is higher than a priority of the TSN frame.

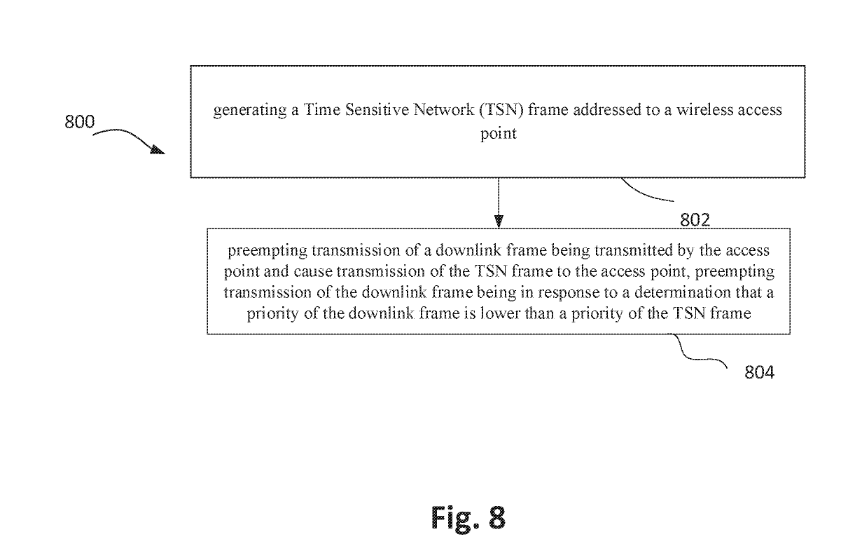

FIG. 8 illustrates a method 700 of operating a wireless communication device according to some demonstrative embodiments. The method 800 may begin with operation 802, which includes generating a Time Sensitive Network (TSN) frame addressed to a wireless access point. At operation 804, the method includes preempting transmission of a downlink frame being transmitted by the access point and cause transmission of the TSN frame to the access point, preempting transmission of the downlink frame being in response to a determination that a priority of the downlink frame is lower than a priority of the TSN frame.

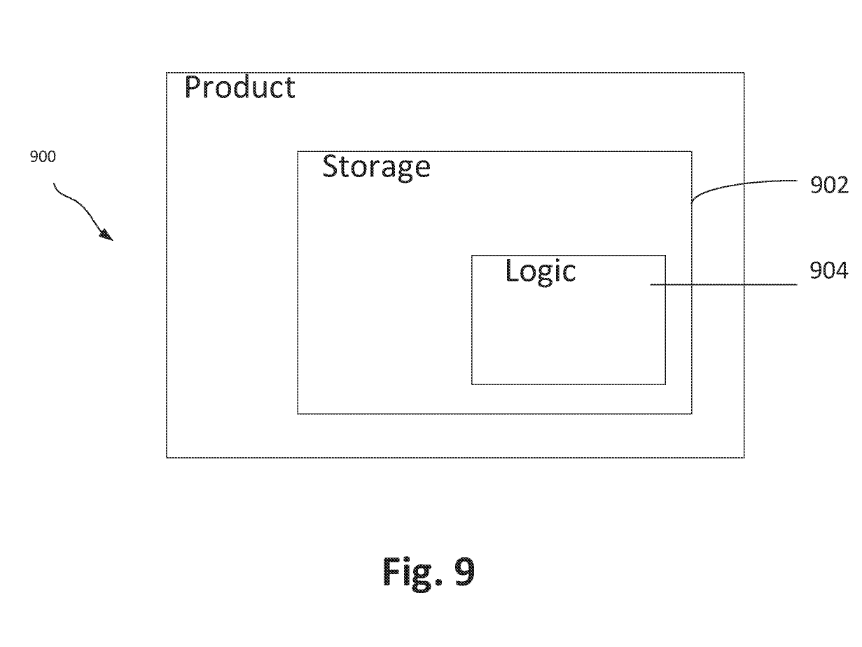

FIG. 9 illustrates a product of manufacture 900, in accordance with some demonstrative embodiments. Product 900 may include one or more tangible computer-readable non-transitory storage media 902, which may include computer-executable instructions, e.g., implemented by logic 904, operable to, when executed by at least one computer processor, enable the at least one computer processor to implement one or more operations at one or more STAs or APs, and/or to perform one or more operations described above with respect to FIGS. 1-6c, and/or one or more operations described herein. The phrase “non-transitory machine-readable medium” is directed to include all computer-readable media, with the sole exception being a transitory propagating signal.

In some demonstrative embodiments, product 900 and/or storage media 902 may include one or more types of computer-readable storage media capable of storing data, including volatile memory, non-volatile memory, removable or non-removable memory, erasable or non-erasable memory, writeable or re-writeable memory, and the like. For example, storage media 902 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 904 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 904 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

Some demonstrative embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. Those instructions may then be read and executed by one or more processors to cause the system 200 of FIG. 2 to perform the methods and/or operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

### EXAMPLES

The following examples pertain to further embodiments.

Example 1 includes a wireless communication device comprising a memory and processing circuitry coupled to the memory, the processing circuitry including logic, the processing circuitry configured to: generate a Time Sensitive Network (TSN) frame addressed to a wireless access point; preempt transmission of a downlink frame being transmitted by the access point and cause transmission of the TSN frame to the access point, preempting transmission of the downlink frame being in response to a determination that a priority of the downlink frame is lower than a priority of the TSN frame; and cause transmission of the TSN frame to the access point during transmission of the downlink frame by the access point in full duplex in response to a determination that the priority of the downlink frame is higher than a priority of the TSN frame.

Example 2 includes the subject matter of Example 1, and optionally, wherein the processing circuitry is further configured to preempt transmission of the downlink frame in response to at least one of a determination that a probability of interference between the downlink frame and the TSN frame is greater than a predetermined interference threshold, and a determination that a maximum latency requirement of the TSN frame would be violated by not transmitting the TSN frame during a time period allocated to transmission of the downlink frame.

Example 3 includes the subject matter of Example 1, and optionally, wherein the processing circuitry is further configured to delay causing transmission of the TSN frame until after completion of transmission of the downlink frame in response to a determination that a priority of the downlink frame is greater than or equal to the priority of the TSN frame.

Example 4 includes the subject matter of Example 1, and optionally, wherein the processing circuitry is further configured to adapt a Physical Layer (PHY) transmission parameter thereof, before causing transmission of the TSN frame to the access point during transmission of the downlink frame by the access point in full duplex, in response to a determination that the priority of the downlink frame is equal to a priority of the TSN frame.

Example 5 includes the subject matter of Example 4, and optionally, wherein the processing circuitry is further configured to adapt the Physical Layer (PHY) transmission parameter thereof by lowering a transmission power for transmission of the TSN frame.

Example 6 includes the subject matter of Example 1, and optionally, wherein the processing circuitry is further configured to delay causing transmission of the TSN frame until after completion of transmission of the downlink frame in response to at least one of: a determination that a minimum latency of the TSN frame would be violated by preempting the downlink frame and transmitting of the TSN frame; or a determination that a maximum latency of the TSN frame would not be violated by transmitting of the TSN frame during a time period allocated to transmission of the downlink frame.

Example 7 includes the subject matter of any one of Examples 1-6, and optionally, wherein the processing circuitry is further configured to, in response to a determination that a maximum latency requirement of the TSN frame would be violated by a time difference greater than a predetermined maximum latency offset, perform one of: preempting transmission of the downlink frame and cause transmission of a Time Sensitive Network (TSN) frame to the access point; and cause transmission of the TSN frame to the access point during transmission of the downlink frame by the access point in full duplex in response to a determination that the priority of the downlink frame is higher than a priority of the TSN frame.

Example 8 includes the subject matter of any one of Examples 1-6, and optionally, wherein the processing circuitry is further configured to, in response to a determination that a maximum latency requirement of the TSN frame would be violated by a time difference lower than a predetermined maximum latency offset, and to a determination that a probability of interference of the TSN frame with a Block Acknowledgment (BA) frame from a station receiving the downlink frame would be lower than a predetermined BA interference threshold, perform one of: preempting transmission of the downlink frame and cause transmission of a Time Sensitive Network (TSN) frame to the access point; and cause transmission of the TSN frame to the access point during transmission of the downlink frame by the access point in full duplex in response to a determination that the priority of the downlink frame is higher than a priority of the TSN frame.

Example 9 includes the subject matter of any one of Examples 1-6, and optionally, wherein the TSN frame includes information to indicate to the access point to preempt transmission of the downlink frame.

Example 10 includes the subject matter of Example 9, and optionally, wherein the TSN frame includes a Medium Access Control (MAC) header, the MAC header including the information.

Example 11 includes the subject matter of any one of Examples 1-6, and optionally, wherein the processing circuitry is further configured to generate a Control Frame having at least one field including information to indicate to the access point to preempt transmission of the downlink frame, and to cause transmission of the Control Frame to the access point prior to causing transmission of the TSN frame to the access point.

Example 12 includes the subject matter of any one of Examples 1-6, and optionally, further including a radio integrated circuit coupled to the processing circuitry to transmit the TSN frame.

Example 13 includes the subject matter of Example 12, and optionally, further including one or more antennas coupled to the radio integrated circuit.

Example 14 includes a method of operating a wireless communication device, the method including: generating a Time Sensitive Network (TSN) frame addressed to a wireless access point; preempting transmission of a downlink frame being transmitted by the access point and cause transmission of the TSN frame to the access point, preempting transmission of the downlink frame being in response to a determination that a priority of the downlink frame is lower than a priority of the TSN frame; and causing transmission of the TSN frame to the access point during transmission of the downlink frame by the access point in full duplex in response to a determination that the priority of the downlink frame is higher than a priority of the TSN frame.

Example 15 includes the subject matter of Example 14, and optionally, further including preempting transmission of the downlink frame in response to at least one of a determination that a probability of interference between the downlink frame and the TSN frame is greater than a predetermined interference threshold, and a determination that a maximum latency requirement of the TSN frame would be violated by not transmitting the TSN frame during a time period allocated to transmission of the downlink frame.

Example 16 includes the subject matter of Example 14, and optionally, further including delaying causing transmission of the TSN frame until after completion of transmission of the downlink frame in response to a determination that a priority of the downlink frame is greater than the priority of the TSN frame.

Example 17 includes the subject matter of Example 14, and optionally, further including adapting a Physical Layer (PHY) transmission parameter of the device, before causing transmission of the TSN frame to the access point during transmission of the downlink frame by the access point in full duplex, in response to the determination that the priority of the downlink frame is higher than a priority of the TSN frame.

Example 18 includes the subject matter of Example 17, and optionally, further including adapting the Physical Layer (PHY) transmission parameter thereof by lowering a transmission power for transmission of the TSN frame.

Example 19 includes the subject matter of Example 14, and optionally, further including delaying causing transmission of the TSN frame until after completion of transmission of the downlink frame in response to at least one of: a determination that a minimum latency of the TSN frame would be violated by preempting the downlink frame and transmitting of the TSN frame; or a determination that a maximum latency of the TSN frame would not be violated by transmitting of the TSN frame during a time period allocated to transmission of the downlink frame.

Example 20 includes the subject matter of any one of Examples 14-19, and optionally, further including, in response to a determination that a maximum latency requirement of the TSN frame would be violated by a time difference greater than a predetermined maximum latency offset, perform one of: preempting transmission of the downlink frame and cause transmission of a Time Sensitive Network (TSN) frame to the access point; and causing transmission of the TSN frame to the access point during transmission of the downlink frame by the access point in full duplex in response to a determination that the priority of the downlink frame is higher than a priority of the TSN frame.

Example 21 includes the subject matter of any one of Examples 14-19, and optionally, further including, in response to a determination that a maximum latency requirement of the TSN frame would be violated by a time difference lower than a predetermined maximum latency offset, and to a determination that a probability of interference of the TSN frame with a Block Acknowledgment (BA) frame from a station receiving the downlink frame would be lower than a predetermined BA interference threshold, perform one of: preempting transmission of the downlink frame and cause transmission of a Time Sensitive Network (TSN) frame to the access point; and causing transmission of the TSN frame to the access point during transmission of the downlink frame by the access point in full duplex in response to a determination that the priority of the downlink frame is higher than a priority of the TSN frame.

Example 22 includes the subject matter of any one of Examples 14-19, and optionally, wherein the TSN frame includes information to indicate to the access point to preempt transmission of the downlink frame.

Example 23 includes the subject matter of Example 22, and optionally, wherein the TSN frame includes a Medium Access Control (MAC) header, the MAC header including the information.

Example 24 includes the subject matter of any one of Examples 14-19, and optionally, further including generating a Control Frame having at least one field including information to indicate to the access point to preempt transmission of the downlink frame, and to cause transmission of the Control Frame to the access point prior to causing transmission of the TSN frame to the access point.

Example 25 includes a product comprising one or more tangible computer-readable non-transitory storage media comprising computer-executable instructions operable to, when executed by at least one computer processor, cause the at least one computer processor to implement operations at a wireless communication device, the operations comprising: generating a Time Sensitive Network (TSN) frame addressed to a wireless access point; preempting transmission of a downlink frame being transmitted by the access point and cause transmission of the TSN frame to the access point, preempting transmission of the downlink frame being in response to a determination that a priority of the downlink frame is lower than a priority of the TSN frame; and causing transmission of the TSN frame to the access point during transmission of the downlink frame by the access point in full duplex in response to a determination that the priority of the downlink frame is higher than a priority of the TSN frame.

Example 26 includes the subject matter of Example 25, and optionally, wherein the operations further include preempting transmission of the downlink frame in response to at least one of a determination that a probability of interference between the downlink frame and the TSN frame is greater than a predetermined interference threshold, and a determination that a maximum latency requirement of the TSN frame would be violated by not transmitting the TSN frame during a time period allocated to transmission of the downlink frame.

Example 27 includes the subject matter of Example 25, and optionally, wherein the operations further include delaying causing transmission of the TSN frame until after completion of transmission of the downlink frame in response to a determination that a priority of the downlink frame is greater than the priority of the TSN frame.

Example 28 includes the subject matter of Example 25, and optionally, wherein the operations further include adapting a Physical Layer (PHY) transmission parameter of the device, before causing transmission of the TSN frame to the access point during transmission of the downlink frame by the access point in full duplex, in response to the determination that the priority of the downlink frame is higher than a priority of the TSN frame.

Example 29 includes the subject matter of Example 28, and optionally, wherein the operations further include adapting the Physical Layer (PHY) transmission parameter thereof by lowering a transmission power for transmission of the TSN frame.

Example 30 includes the subject matter of any one of Examples 25-29, and optionally, wherein the operations further include delaying causing transmission of the TSN frame until after completion of transmission of the downlink frame in response to at least one of: a determination that a minimum latency of the TSN frame would be violated by preempting the downlink frame and transmitting of the TSN frame; or a determination that a maximum latency of the TSN frame would not be violated by transmitting of the TSN frame during a time period allocated to transmission of the downlink frame.

Example 31 includes the subject matter of any one of Examples 25-29, and optionally, wherein the operations further include, in response to a determination that a maximum latency requirement of the TSN frame would be violated by a time difference greater than a predetermined maximum latency offset, perform one of: preempting transmission of the downlink frame and cause transmission of a Time Sensitive Network (TSN) frame to the access point; and causing transmission of the TSN frame to the access point during transmission of the downlink frame by the access point in full duplex in response to a determination that the priority of the downlink frame is higher than a priority of the TSN frame.

Example 32 includes the subject matter of any one of Examples 25-29, and optionally, wherein the operations further include, in response to a determination that a maximum latency requirement of the TSN frame would be violated by a time difference lower than a predetermined maximum latency offset, and to a determination that a probability of interference of the TSN frame with a Block Acknowledgment (BA) frame from a station receiving the downlink frame would be lower than a predetermined BA interference threshold, perform one of: preempting transmission of the downlink frame and cause transmission of a Time Sensitive Network (TSN) frame to the access point; and causing transmission of the TSN frame to the access point during transmission of the downlink frame by the access point in full duplex in response to a determination that the priority of the downlink frame is higher than a priority of the TSN frame.

Example 33 includes the subject matter of any one of Examples 25-29, and optionally, wherein the TSN frame includes information to indicate to the access point to preempt transmission of the downlink frame.

Example 34 includes the subject matter of Example 33, and optionally, wherein the TSN frame includes a Medium Access Control (MAC) header, the MAC header including the information.

Example 35 includes the subject matter of any one of Examples 25-29, and optionally, wherein the operations further include generating a Control Frame having at least one field including information to indicate to the access point to preempt transmission of the downlink frame, and to cause transmission of the Control Frame to the access point prior to causing transmission of the TSN frame to the access point.

Example 36 includes a wireless communication device comprising a memory and processing circuitry coupled to the memory, the processing circuitry including logic, the processing circuitry configured to: cause transmission of a downlink frame to a first wireless station; preempt the downlink frame and decode a Time Sensitive Network (TSN) frame in response to a determination that a priority of the downlink frame is lower than a priority of the TSN frame.

Example 37 includes the subject matter of Example 36, and optionally, wherein the processing circuitry is further configured to: preempt the downlink frame and decode the TSN frame in response to a determination that the priority of the downlink frame is lower than the priority of the TSN frame, and to a determination that a probability of interference between the downlink frame and the TSN frame is greater than a predetermined interference threshold; and decode the TSN frame and continue transmission of the downlink frame in full duplex in response to a determination that a priority of the downlink frame is lower than to a priority of the TSN frame, and a determination that a probability of interference between the downlink frame and the TSN frame is lower than the predetermined interference threshold.

Example 38 includes the subject matter of Example 37, and optionally, wherein the processing circuitry is further configured to continue transmission of the downlink frame in full duplex in response to a determination that a priority of the downlink frame is greater than a priority of the TSN frame.

Example 39 includes the subject matter of Example 36, and optionally, wherein the processing circuitry is further configured to resume causing transmission, after preemption of the downlink frame, of a remaining portion of the downlink frame in response to a determination that a Network Allocation Vector set by the downlink frame has not expired after completion of the TSN frame.

Example 40 includes the subject matter of any one of Examples 36-39, and optionally, wherein the processing circuitry is further configured to enter a contention based channel access mode to cause transmission of a remaining portion of the downlink frame, after preemption of the downlink frame, in response to a determination that a Network Allocation Vector set by the downlink frame has expired after completion of the TSN frame.

Example 41 includes the subject matter of any one of Examples 36-39, and optionally, wherein the processing circuitry is further to preempt transmission of the downlink frame based on decoding information in the TSN frame indicating that the downlink frame is to be preempted.

Example 42 includes the subject matter of Example 41, and optionally, wherein the processing circuitry is to decode a Medium Access Control (MAC) header of the TSN frame, the MAC header including the information.

Example 43 includes the subject matter of any one of Examples 36-39, and optionally, wherein the processing circuitry is further to preempt transmission of the downlink frame based on decoding a Control Frame from the second wireless device, the Control Frame having at least one field including information indicating that the downlink frame is to be preempted.

Example 44 includes the subject matter of any one of Examples 36-39, and optionally, further including a radio integrated circuit coupled to the processing circuitry to receive the TSN frame and to transmit the downlink frame.

Example 45 includes the subject matter of Example 44, and optionally, further including one or more antennas coupled to the radio integrated circuit.

Example 46 includes a method of operating a wireless communication device, the method comprising: causing transmission of a downlink frame to a first wireless station; preempting the downlink frame and decode a Time Sensitive Network (TSN) frame in response to a determination that a priority of the downlink frame is lower than a priority of the TSN frame.

Example 47 includes the subject matter of Example 46, and optionally, further comprising: preempting the downlink frame and decode the TSN frame in response to a determination that the priority of the downlink frame is lower than the priority of the TSN frame, and to a determination that a probability of interference between the downlink frame and the TSN frame is greater than a predetermined interference threshold; and decoding the TSN frame and continue transmission of the downlink frame in full duplex in response to a determination that a priority of the downlink frame is lower than to a priority of the TSN frame, and a determination that a probability of interference between the downlink frame and the TSN frame is lower than the predetermined interference threshold.

Example 48 includes the subject matter of Example 47, and optionally, further comprising continuing transmission of the downlink frame in full duplex in response to a determination that a priority of the downlink frame is greater than a priority of the TSN frame.

Example 49 includes the subject matter of any one of Examples 46-48, and optionally, further comprising resuming causing transmission, after preemption of the downlink frame, of a remaining portion of the downlink frame in response to a determination that a Network Allocation Vector set by the downlink frame has not expired after completion of the TSN frame.

Example 50 includes the subject matter of any one of Examples 46-48, and optionally, further comprising entering a contention based channel access mode to cause transmission of a remaining portion of the downlink frame, after preemption of the downlink frame, in response to a determination that a Network Allocation Vector set by the downlink frame has expired after completion of the TSN frame.

Example 51 includes the subject matter of any one of Examples 46-48, and optionally, further comprising preempting transmission of the downlink frame based on decoding information in the TSN frame indicating that the downlink frame is to be preempted.

Example 52 includes the subject matter of Example 51, and optionally, further comprising decoding a Medium Access Control (MAC) header of the TSN frame, the MAC header including the information.

Example 53 includes the subject matter of any one of Examples 46-48, and optionally, further comprising preempting transmission of the downlink frame based on decoding a Control Frame from the second wireless device, the Control Frame having at least one field including information indicating that the downlink frame is to be preempted.

Example 54 includes a product comprising one or more tangible computer-readable non-transitory storage media comprising computer-executable instructions operable to, when executed by at least one computer processor, cause the at least one computer processor to implement operations at a wireless communication device, the operations comprising: causing transmission of a downlink frame to a first wireless station; preempting the downlink frame and decode a Time Sensitive Network (TSN) frame in response to a determination that a priority of the downlink frame is lower than a priority of the TSN frame.

Example 55 includes the subject matter of Example 54, and optionally, wherein the operations further comprising: preempting the downlink frame and decode the TSN frame in response to a determination that the priority of the downlink frame is lower than the priority of the TSN frame, and to a determination that a probability of interference between the downlink frame and the TSN frame is greater than a predetermined interference threshold; and decoding the TSN frame and continue transmission of the downlink frame in full duplex in response to a determination that a priority of the downlink frame is lower than to a priority of the TSN frame, and a determination that a probability of interference between the downlink frame and the TSN frame is lower than the predetermined interference threshold

Example 56 includes the subject matter of Example 55, and optionally, wherein the operations further comprising continuing transmission of the downlink frame in full duplex in response to a determination that a priority of the downlink frame is greater than a priority of the TSN frame.

Example 57 includes the subject matter of any one of Examples 54-56, and optionally, wherein the operations further comprising resuming causing transmission, after preemption of the downlink frame, of a remaining portion of the downlink frame in response to a determination that a Network Allocation Vector set by the downlink frame has not expired after completion of the TSN frame.

Example 58 includes the subject matter of Example 57, and optionally, wherein the operations further comprising entering a contention based channel access mode to cause transmission of a remaining portion of the downlink frame, after preemption of the downlink frame, in response to a determination that a Network Allocation Vector set by the downlink frame has expired after completion of the TSN frame.

Example 59 includes the subject matter of any one of Examples 54-56, and optionally, wherein the operations further comprising preempting transmission of the downlink frame based on decoding information in the TSN frame indicating that the downlink frame is to be preempted.

Example 60 includes the subject matter of Example 59, and optionally, wherein the operations further comprising decoding a Medium Access Control (MAC) header of the TSN frame, the MAC header including the information.

Example 61 includes the subject matter of any one of Examples 54-56, and optionally, wherein the operations further comprising preempting transmission of the downlink frame based on decoding a Control Frame from the second wireless device, the Control Frame having at least one field including information indicating that the downlink frame is to be preempted.

An Abstract is provided. It is submitted with the understanding that it will not be used to limit or interpret the scope or meaning of the claims. The following claims are hereby incorporated into the detailed description, with each claim standing on its own as a separate embodiment.

What is claimed is:

1. A wireless communication device comprising a memory and processing circuitry coupled to the memory, the processing circuitry including logic, the processing circuitry configured to:
generate a Time Sensitive Network (TSN) frame addressed to a wireless access point;
preempt transmission of a downlink frame being transmitted by the access point and cause transmission of the TSN frame to the access point, preempting transmission of the downlink frame being in response to a determination that a priority of the downlink frame is lower than a priority of the TSN frame; and
cause transmission of the TSN frame to the access point during transmission of the downlink frame by the access point in full duplex in response to a determination that the priority of the downlink frame is higher than a priority of the TSN frame.

2. The device of claim 1, wherein the processing circuitry is further configured to preempt transmission of the downlink frame in response to at least one of a determination that a probability of interference between the downlink frame and the TSN frame is greater than a predetermined interference threshold, and a determination that a maximum latency requirement of the TSN frame would be violated by not transmitting the TSN frame during a time period allocated to transmission of the downlink frame.

3. The device of claim 1, wherein the processing circuitry is further configured to delay causing transmission of the TSN frame until after completion of transmission of the downlink frame in response to a determination that a priority of the downlink frame is greater than or equal to the priority of the TSN frame.

4. The device of claim 1, wherein the processing circuitry is further configured to adapt a Physical Layer (PHY) transmission parameter thereof, before causing transmission of the TSN frame to the access point during transmission of the downlink frame by the access point in full duplex, in response to a determination that the priority of the downlink frame is equal to a priority of the TSN frame.

5. The device of claim 1, wherein the processing circuitry is further configured to delay causing transmission of the TSN frame until after completion of transmission of the downlink frame in response to at least one of:
a determination that a minimum latency of the TSN frame would be violated by preempting the downlink frame and transmitting of the TSN frame; or
a determination that a maximum latency of the TSN frame would not be violated by transmitting of the TSN frame during a time period allocated to transmission of the downlink frame.

6. The device of claim 1, wherein the processing circuitry is further configured to, in response to a determination that a maximum latency requirement of the TSN frame would be violated by a time difference greater than a predetermined maximum latency offset, perform one of:
preempting transmission of the downlink frame and cause transmission of a Time Sensitive Network (TSN) frame to the access; and
cause transmission of the TSN frame to the access point during transmission of the downlink frame by the access point in full duplex in response to a determination that the priority of the downlink frame is higher than a priority of the TSN frame.

7. The device of claim 1, wherein the processing circuitry is further configured to, in response to a determination that a maximum latency requirement of the TSN frame would be violated by a time difference lower than a predetermined maximum latency offset, and to a determination that a probability of interference of the TSN frame with a Block Acknowledgment (BA) frame from a station receiving the downlink frame would be lower than a predetermined BA interference threshold, perform one of:
preempting transmission of the downlink frame and cause transmission of a Time Sensitive Network (TSN) frame to the access; and
cause transmission of the TSN frame to the access point during transmission of the downlink frame by the access point in full duplex in response to a determination that the priority of the downlink frame is higher than a priority of the TSN frame.

8. The device of claim 1, wherein the TSN frame includes a Medium Access Control (MAC) header, the MAC header including information to indicate to the access point to preempt transmission of the downlink frame.

9. The device of claim 1, wherein the processing circuitry is further configured to generate a Control Frame having at least one field including information to indicate to the access point to preempt transmission of the downlink frame, and to cause transmission of the Control Frame to the access point prior to causing transmission of the TSN frame to the access point.

10. The device of claim 1, further including a radio integrated circuit coupled to the processing circuitry to transmit the TSN frame.

11. The device of claim 10, further including one or more antennas coupled to the radio integrated circuit.

12. A wireless communication device including:
means for generating a Time Sensitive Network (TSN) frame addressed to a wireless access point;
means for preempting transmission of a downlink frame being transmitted by the access point and cause transmission of the TSN frame to the access point, preempting transmission of the downlink frame being in response to a determination that a priority of the downlink frame is lower than a priority of the TSN frame; and
means for causing transmission of the TSN frame to the access point during transmission of the downlink frame by the access point in full duplex in response to a determination that the priority of the downlink frame is higher than a priority of the TSN frame.

13. The device of claim 12, further including means for preempting transmission of the downlink frame in response to at least one of a determination that a probability of interference between the downlink frame and the TSN frame is greater than a predetermined interference threshold, and a determination that a maximum latency requirement of the TSN frame would be violated by not transmitting the TSN frame during a time period allocated to transmission of the downlink frame.

14. The device of claim 12, further including means for delaying causing transmission of the TSN frame until after completion of transmission of the downlink frame in response to a determination that a priority of the downlink frame is greater than the priority of the TSN frame.

15. The device of claim 12, further including means for adapting a Physical Layer (PHY) transmission parameter of the device, before causing transmission of the TSN frame to the access point during transmission of the downlink frame by the access point in full duplex, in response to the determination that the priority of the downlink frame is higher than a priority of the TSN frame.

16. A product comprising one or more tangible computer-readable non-transitory storage media comprising computer-executable instructions operable to, when executed by at least one computer processor, cause the at least one computer processor to implement operations at a wireless communication device, the operations comprising:
generating a Time Sensitive Network (TSN) frame addressed to a wireless access point;
preempting transmission of a downlink frame being transmitted by the access point and cause transmission of the TSN frame to the access point, preempting transmission of the downlink frame being in response to a determination that a priority of the downlink frame is lower than a priority of the TSN frame; and
causing transmission of the TSN frame to the access point during transmission of the downlink frame by the access point in full duplex in response to a determination that the priority of the downlink frame is higher than a priority of the TSN frame.

17. The product of claim 16, wherein the operations further include preempting transmission of the downlink frame in response to at least one of a determination that a probability of interference between the downlink frame and the TSN frame is greater than a predetermined interference threshold, and a determination that a maximum latency requirement of the TSN frame would be violated by not transmitting the TSN frame during a time period allocated to transmission of the downlink frame.

18. The product of claim 16, wherein the operations further include delaying causing transmission of the TSN frame until after completion of transmission of the downlink frame in response to a determination that a priority of the downlink frame is greater than the priority of the TSN frame.

19. The product of claim 16, wherein the operations further include adapting a Physical Layer (PHY) transmission parameter of the device, before causing transmission of the TSN frame to the access point during transmission of the downlink frame by the access point in full duplex, in response to the determination that the priority of the downlink frame is higher than a priority of the TSN frame.

20. The product of claim 19, wherein the operations further include adapting the Physical Layer (PHY) transmission parameter thereof by lowering a transmission power for transmission of the TSN frame.

21. The product of claim 16, wherein the operations further include delaying causing transmission of the TSN frame until after completion of transmission of the downlink frame in response to at least one of:
a determination that a minimum latency of the TSN frame would be violated by preempting the downlink frame and transmitting of the TSN frame; or
a determination that a maximum latency of the TSN frame would not be violated by transmitting of the TSN frame during a time period allocated to transmission of the downlink frame.

22. The product of claim 16, wherein the operations further include, in response to a determination that a maximum latency requirement of the TSN frame would be violated by a time difference greater than a predetermined maximum latency offset, perform one of:
preempting transmission of the downlink frame and cause transmission of a Time Sensitive Network (TSN) frame to the access; and
causing transmission of the TSN frame to the access point during transmission of the downlink frame by the access point in full duplex in response to a determination that the priority of the downlink frame is higher than a priority of the TSN frame.

23. The product of claim 16, wherein the operations further include, in response to a determination that a maximum latency requirement of the TSN frame would be violated by a time difference lower than a predetermined maximum latency offset, and to a determination that a probability of interference of the TSN frame with a Block Acknowledgment (BA) frame from a station receiving the downlink frame would be lower than a predetermined BA interference threshold, perform one of:
preempting transmission of the downlink frame and cause transmission of a Time Sensitive Network (TSN) frame to the access; and
causing transmission of the TSN frame to the access point during transmission of the downlink frame by the access point in full duplex in response to a determination that the priority of the downlink frame is higher than a priority of the TSN frame.

24. The product of claim 23, wherein the TSN frame includes a Medium Access Control (MAC) header, the MAC header including information to indicate to the access point to preempt transmission of the downlink frame.

25. The product of claim 16, wherein the operations further include generating a Control Frame having at least one field including information to indicate to the access point to preempt transmission of the downlink frame, and to cause transmission of the Control Frame to the access point prior to causing transmission of the TSN frame to the access point.
